(19) United States
(12) Patent Application Publication
(10) Pub. No.: US 2025/0011575 A1
(43) Pub. Date: Jan. 9, 2025

(54) METHOD FOR STABILISATION OF POLYMER MATERIALS

(71) Applicant: SABIC GLOBAL TECHNOLOGIES B.V., Bergen op Zoom (NL)

(72) Inventors: Karel WILSENS, Veldhoven (NL); Rajesh CHITTA, Riyadh (SA); Luke HERINX, Brunssum (NL); Kankan BHAUMIK, Bangalore (IN)

(21) Appl. No.: 18/707,331

(22) PCT Filed: Sep. 15, 2022
(86) PCT No.: PCT/EP2022/075674

§ 371 Date: May 3, 2024

(30) Foreign Application Priority Data
Nov. 8, 2021 (IN) 202141051042

(51) Int. Cl. C08K 5/526; C08J 3/20; C08K 5/098; C08L 23/06

(52) U.S. Cl. CPC C08K 5/526; C08J 3/201; C08K 5/098; C08L 23/06; C08J 2323/06; C08J 2423/12; C08K 2201/014; C08L 2201/08; C08L 2205/025; C08L 2207/062; C08L 2207/20

(57) ABSTRACT

a method for stabilising a material composition containing polyethylene includes: i)
providing a material composition containing polyethylene; ii) determining the quantity of vinyl unsaturations in the polyethylene; iii) determining the quantity of secondary antioxidant in the material composition; iv) adding a quantity of secondary antioxidant so that the quantity of secondary antioxidant in the polyethylene is as required for a polyethylene having a quantity of vinyl unsaturations as determined under ii) to obtain a modified material composition. The method allows for obtaining a modified material composition that can be used in the production of articles via thermal shaping processes, such as extrusion or injection moulding processes, without excessive increase of long chain braches as a consequence of the shaping process.

### CROSS REFERENCE TO RELATED APPLICATIONS

This application is a National Stage application of PCT/EP2022/075674, filed Sep. 15, 2022, which claims the benefit of IN202141051042, filed Nov. 8, 2021, both of which are incorporated by reference in their entirety herein.

### BACKGROUND

The present invention relates to stabilisation of polymer materials. In particular, the invention relates to stabilisation of polymer materials comprising polyethylenes, and polymer materials consisting of polyethylenes.

Polymer materials are presently ubiquitously used in a wide variety of applications, including in durable and single-use goods, in rigid and flexible applications. To ensure that such polymer materials are equipped for a service life that is typical for its application, it needs to be safeguarded that the polymer chains in the materials are sufficiently inert vis-à-vis circumstances to which the materials are subjected during their service life. In certain situations, polymer materials may exhibit certain reactivity as a result of external circumstances that may lead to reduction or loss of properties of the materials that are required for its function in the particular application. Accordingly, a polymer materials needs to be equipped to deal with such circumstances.

Presently, the term service life may be considered to be subject to extended interpretation. Where typically the service life would encompass the cycle that originates from the production of the polymer material and/or its formulation, further including a process of shaping, incorporation in a product such as a consumer or industrial product, the use by consumers or industry, and the discard of such product as waste, increasingly there is now emphasis on extending the service life of the polymer by recycling. Such recycling may involve the re-use of the polymer material by converting a batch of matter comprising the polymer material via a recycling process that may involve compiling a suitable material formulation and/or applying the material to a shaping process to create a new product that again may find its way to e.g. consumers.

In order for the polymer material to withstand this extended service life, and to ensure that is does so whilst complying to the material requirements set for use in whatever product application the material may end up in, it is required that the reactivity of the polymer material under circumstances of environment, use and processing that it is subject to is adequately mitigated. Where that would not be done adequately, defects in the material may be cause for rejection of products; for example, rigid packages such as plastic bottles may become too brittle and thereby lead to leakages; flexible packages such as plastic films and sheets may include and overly high quantity of gels which lead to deterioration of the mechanical properties of such films; and degradation of the polymer material may lead to molecular weight change and as a consequence thereof an altered melt flow, which may negatively impact manufacturing processes of products comprising such polymers.

Accordingly, it will be obvious that these effects need to be mitigated.

### SUMMARY

A particular phenomenon that may occur during a polymer's service life, including during thermal re-processing of polymer materials, is the generation of long chain branches. Generation of long chain branches is believed to occur due to chain scissions or hydrogen abstraction in the polymer chains, resulting in the formation of certain radicals, which may join to form a polymer chain with increased long chain branches. This phenomenon is particularly known to occur in polyethylene materials. It may be induced thermally and/or mechanically. In particular, when polymer materials are recycled after use, they typically are subjected to melt-shaping processes in order to convert the polymer materials from the form in which they were obtained as waste into a form that is suitable for renewed use. Such exposure to high temperatures, such as in extrusion or injection moulding processes, is believed to contribute to long chain branch formation.

Now, to contribute to mitigation of the effects as outlined above, the present invention provides such by a method for stabilising a material composition comprising polyethylene, the method comprising:
i) providing a material composition comprising or consisting of polyethylene;
ii) determining the quantity of vinyl unsaturations in the polyethylene;
iii) determining the quantity of secondary antioxidant in the material composition;
iv) adding a quantity of secondary antioxidant so that the quantity of secondary antioxidant in the polyethylene is as required for a polyethylene having a quantity of vinyl unsaturations as determined under ii) to obtain a modified material composition.

Processing of a material composition according to this method allows for obtaining a modified material composition that can be used in the production of articles via thermal shaping processes, such as extrusion or injection moulding processes, without excessive increase of long chain branches as a consequence of the shaping process.

### DETAILED DESCRIPTION

In the method of the present invention, the vinyl unsaturation content may for example be determined as the vinyl index. The vinyl index may be calculated from the absorbance spectrum as obtained via Fourier Transform Infrared (FTIR) analysis performed in transmission mode. To obtain the value for the vinyl index on the basis of an FTIR spectrum, the below equation is to be applied:

$$VI = \frac{{A}_{908} - {A}_{933}}{{A}_{1897} - {A}_{1986}}$$

wherein A₉₀₈ is the absorbance at 908 cm⁻¹, A₉₃₃ is the absorbance at 933 cm⁻¹, A₁₈₉₇ is the absorbance at 1897 cm⁻¹, and A₁₉₈₆ is the absorbance at 1986 cm⁻¹ of a sample of the material composition.

The FTIR spectrum of the material to be tested may for example be tested according to the method of ASTM D5576-00 (2006).

It is preferred that the vinyl index of the polyethylene is ≥0.5 and ≤5.0, preferably ≥1.0 and ≤3.0, more preferably ≥1.4 and ≤2.5. When polyethylenes having such vinyl index are used, the mitigation of the detrimental effects occurring during the material's service life and during thermal (re) processing via the stabilisation method of the present invention is particularly adequate.

The secondary antioxidant may for example be a phosphite. For example, the secondary antioxidant may be a monophosphite, a diphosphite or a polyphosphite.

Suitable monophosphites that may be used as secondary antioxidant can be selected from trisnonylphenyl phosphite, trilauryl phosphite, tris(2,4-di-t-butyl phenyl)phosphite, di-isooctyl phosphite, triisodecyl phosphite, diisodecylphenyl phosphite, diphenyl isodecyl phosphite, triphenyl phosphite, tris(tridecyl) phosphite, diphenyl isooctyl phosphite, 2,2-methylene-bis(4,6-di-t-butyl-phenyl)-octyl-phosphite, 2,2′-ethylenebis(4,6-di-t-butyl-phenyl) fluorophosphonite, disodium hydrogen phosphite, bis(2,4-di-t-butyl-6-methylphenyl)ethyl phosphite, 2,4,6-tri-t-butylphenyl-2-butyl-2-ethyl-1,3-propanediol phosphite, triisooctyl phosphite, tris(dipropyleneglycol) phosphite, diisooctyl octylphenyl phosphite, tris(2,4-di-t-butyl-5-methylphenyl)phosphite, diphenyl phosphite, phenyl neopentyleneglycol phosphite, tristearyl phosphite, dinonylphenyl bis(nonylphenyl) phosphite, isooctyl phenyl phosphite, 2-ethylhexyl diphenyl phosphite, and diphenyl tridecyl phosphite.

Suitable diphosphites that may be used as secondary antioxidant can be selected from distearyl pentaerythritol diphosphite, tetrakis-(2,4-di-t-butyl-phenyl)-4,4′-bi-phenylene-di-phosphonite, bis(2,4-di-t-butylphenyl) pentaerythritol diphosphite, bis-(2,6-di-t-butyl-4-methyl-phenyl)-pentaerythritol-di-phosphite, bis(2,4,6-tri-t-butylphenyl) pentaerythritol diphosphite, tetrakis isodecyl 4,4′-isopropylidene diphosphite, bis-(2,4-dicumylphenyl)-pentaerythritol diphosphite, tetraphenyl dipropyleneglycol diphosphite, bis(nonylphenyl) pentaerythritol diphosphite, diisodecyl pentaerythritol diphosphite, tetra(tridecyl)-4,4′-butylidene-bis(6-t-butyl-2-methyldiphenyl)diphosphite, and tetrakis(2,4-di-t-butyl-5-methylphenyl)-4,4′-bi-phenylene diphosphonite.

Suitable polyphosphites that may be used as secondary antioxidant can be selected from poly(dipropyleneglycol) phenyl phosphite, 2,2′,2″-nitrilo triethyl-tris(3,3′,5,5′-tetra-t-butyl-1,1′-biphenyl-2,2′-diyl)phosphite, dipropyleneglycol phosphite, and 1,1,3-tris(2-methyl-4-(ditridecyl phosphite)-5-t-butylphenyl) butane.

The secondary antioxidant that is added in step iv) may for example be a monophosphite, preferably tris(2,4-di-t-butyl phenyl)phosphite. A particularly suitable secondary antioxidant is tris(2,4-di-t-butyl phenyl)phosphite.

It is preferred that the ratio of total secondary antioxidant to the vinyl index in the polyethylene in the modified material composition is ≥100 and ≤1000 ppm, preferably ≥100 and ≤500 ppm, more preferably ≥300 and ≤500 ppm by weight.

In the context of the present invention, the total secondary antioxidant content may for example be determined by liquid chromatography. For example, the secondary antioxidant content may be determined according to the method of ASTM D6953-11.

It is preferred that the modified material composition that is obtained via the method of the present invention comprises ≥600 and ≤1500 ppm by weight of secondary antioxidant, with regard to the total weight of the polyethylene in the modified material composition.

The secondary antioxidant that is added in step iv) of the method of the invention may be the same or may be different than the secondary antioxidant that is present in the material composition as analysed under step iii). The analysis under step iii) may show the presence of the content of secondary antioxidants.

In the context of the present invention, the total secondary antioxidant content is to be understood to be the total of all compounds identified in step iii) as secondary antioxidants according to the definition thereof herein and the quantity added under step iv). For sake of completeness, it should be understood that any degradation products originating from secondary antioxidant compounds that may be present in a sample that is analysed are not to be included in the total secondary antioxidant content. By so, when using a recycle material, one shall only count the non-degraded remaining secondary antioxidant content in such material as contributing to the total secondary antioxidant content.

The material composition in certain embodiments may for example be a waste plastic composition. The method of the present invention contributes to rendering waste plastic compositions suitable for a renewed use, such as for example in a consumer application. By the method of the invention, certain waste plastics are allowed multiple cycles of use.

The waste plastic composition may for example be a composition comprising ≥70.0 wt % of polyethylene, preferably ≥80.0 wt %, with regard to the total weight of the waste plastic composition. The waste plastic composition may for example comprise ≥20.0 wt %, preferably ≤ 10.0 wt %, of polypropylene, with regard to the total weight of the waste plastic composition. The waste plastic composition may for example comprise ≥1.0 and ≤20.0 wt % of polypropylene, preferably ≥2.0 and ≤10.0 wt %

The polyethylene may for example have a molecular weight distribution M_{w}/Mₙ of ≥2.0 and ≤50.0, preferably of ≥2.0 and ≤20.0, more preferably of ≥5.0 and ≤20.0, wherein M_{w} is the weight-average molecular weight, and Mₙ is the number-average molecular weight, each determined in accordance with ASTM D6774-20.

The polyethylene may for example be a low-density polyethylene (LDPE), a linear low-density polyethylene (LLDPE), a high-density polyethylene (HDPE), or a mixture thereof.

Such LDPE may for example have a density of ≥900 and ≤935 kg/m³, preferably of ≥ 910 and ≤925 kg/m³. An LDPE may for example an ethylene-based homopolymer or copolymer produced via free radical polymerisation, such as high-pressure free-radical polymerisation. For example, such LDPE may be produced via high-pressure tubular reactor processes or via high-pressure autoclave reactor processes.

An LLDPE may for example be an ethylene-based copolymer having a density of ≥850 and ≤940 kg/m³, preferably of ≥890 and ≤925 kg/m³, more preferably of ≥905 and ≤925 kg/m³. The LLDPE may comprise moieties derived from one of more C3-C10 α-olefins, preferably moieties derived from an α-olefin selected from propylene, 1-butene, 4-methyl-1-pentene, 1-hexene, or 1-octene. For example, the LLDPE may comprise ≥5.0 and ≤25.0 wt %, preferably ≥5.0 and ≤20.0 wt %, of moieties derived from an α-olefin selected from propylene, 1-butene, 4-methyl-1-pentene, 1-hexene, or 1-octene, with regard to the total weight of the LLDPE.

An HDPE may for example be an ethylene-based copolymer or homopolymer having a density of ≥940 and ≤975 kg/m³, preferably of ≥945 and ≤970 kg/m³, more preferably of ≥945 and ≤965 kg/m³. The HDPE may comprise moieties derived from one of more C3-C10 α-olefins, preferably moieties derived from an α-olefin selected from propylene, 1-butene, 4-methyl-1-pentene, 1-hexene, or 1-octene. For example, the HDPE may comprise ≥0.2 and <5.0 wt %, preferably ≥0.5 and ≤3.0 wt %, of moieties derived from an α-olefin selected from propylene, 1-butene, 4-methyl-1-pentene, 1-hexene, or 1-octene, with regard to the total weight of the HDPE.

The density of the polyethylenes may be determined in accordance with ASTM D792 (2008).

The modified material composition may for example comprise ≥500 and ≤2500 ppm by weight of a primary antioxidant, and/or ≥500 and ≤2500 ppm by weight of calcium stearate or zinc stearate. The primary antioxidant may for example be selected from methylhydroquinone; 2-t-butyl-hydro-quinonone; diamylhydroquinone; 2-t-butyl-4-methylphenol; styrenated phenol; 3-t-butyl-4-hydroxyanisole; 2,6-di-t-butyl-4-methylphenol; 2,6-di-t-butyl-4-ethyl-phenol; 2,6-di-t-butyl-α-(di-methyl-amino)-p-cresol; 2,6-di-t-butyl-4-sec-butyl-phenol; 2,6-di-t-butyl-4-nonyl-phenol; 2,4-di-methyl-6-(1-methyl-cyclohexyl) phenol; 2,4-dimethyl-6-(1-methyl-pentadecyl)-phenol; 3-(3,5-di-tert·-butyl-4-hydroxyphenyl) propionic acid-methyl-ester; octadecyl 3-(3,5-di-t-butyl-4-hydroxyphenyl) propionate; 2,6-di-phenyl-4-octadecyl-cyclo-oxy-phenol; α-tocopherol; n-propyl 3,4,5-trihydroxybenzoate; phenol, 4-methyl-2,6-bis(2-phenylethenyl)-2,6-distyryryl-p-cresol; 2 (2-phenylethenyl)-4-methyl-6-(1,1-dimethylethyl)-phenol; isooctyl 3-(3,5-di-tert-butyl-4-hydroxyphenyl) propionate; 6-t-butyl-2,4-dimethyl-phenol; dicyclopentyl-p-cresol; 2,6-di-t-butyl-4-n-butylphenol; 4-hydroxymethyl-2,6-di-t-butyl-phenol; 2,6-di-t-butyl-phenol; 3-(3,5-di-tert-butyl-4-hydroxyphenyl) propionic acid hydrazide; 3-(3,5-di-tert·-butyl-4-hydroxyphenyl) propionic acid; 2,4,6 tris t-butyl phenol; 2,5-di-t-butyl-hydroquinone; p-benzoquinone; hydroquinone; hydroquinone-mono-methyl-ether; 2,2′-bis(6-t-butyl-p-cresyl) methane; 2,2′-methylenebis(6-tert-butyl-4-ethylphenol); 2,2′-methylenebis 6-(1-methylcyclohexyl)-p-cresol; 4,4′-butylidene-bis-(6-t-butyl-m-cresol); 2,2′-ethylidenebis(4,6-di-t-butylphenol); phenol, 4,4′-methylenebis [2,6-bis(1,1-dimethylethyl)-4,4′-methylenebis(2,6-di-t-butylphenol); 2,2′-ilsobutylidenebis(4,6-dimethylphenol); bisphenol A; 3,9-bis(2-(3-(3-(tert-butyl-4-hydroxy-5-methyl-phenyl)-propionyl-oxy)-1,1-dimethylethyl]-2,4,8,10-tetraoxospiro(5,5) undecane; tri-ethylene-glycol-bis-3-(t-butyl-4-hydroxy-5-methyl-phenyl)-propionate; hexamethylenebis(3,5-di-t-butyl-4-hydroxycinnamate); benzenepropanamide, N,N′-1,3-propanediylbis [3,5-bis(1,1-dimethylethyl)-4-hydroxy-]N,N′-1,3-Propanediylbis(3,5-di-t-butyl-4-hydroxyhydrocinnamamide); 2,2′-methylenebis(6-nonyl-p-cresol); 1,1,3-tris(2-methyl-4-hydroxy-5-t-butyl phenyl) butane; 1,3,5-trimethyl-2,4,6-tris(3,5-di-t-butyl-4-hydroxybenzyl)benzene; butyric acid, 3,3-bis(3-t-butyl-4-hydroxyphenyl)ethylene ester; tris(3,5-di-t-butyl-4-hydroxy benzyl) isocyanurate; 1,3,5-tris(4-t-butyl-2,6-dimethyl-3-hydroxy-benzyl)-iso-cyanurate; 3-(3,5-di-t-butyl-4-hydroxy-phenyl) propion acid ester with 1,3,5-tris(2-hydroxyethyl)-iso-cyanurate; pentaerythritol tetrakis(3-(3,5-di-t-butyl-4-hydroxyphenyl) propionate; and 2,6-bis(2′-bis-hydroxy-3′-t-butyl-5′-methyl-phenyl-4-methyl-phenol). Preferably, the primary antioxidant is pentaerythritol tetrakis(3-(3,5-di-t-butyl-4-hydroxyphenyl) propionate.

The method of the invention may in certain embodiments comprise a step v) subsequent to steps i)-iv) of processing the modified material composition via a thermal shaping process at a temperature of ≤250° C., preferably of ≤230° C., to obtain a shaped object. Processing the modified material composition at such processing temperatures contributes to the reduction of the quantity of long-chain branches formed during shaping. Thermal shaping processes that may be used in the process step v) may for example be extrusion moulding, injection moulding, extrusion blow moulding, or extrusion film forming processes.

In a certain embodiment, the invention also relates to a material composition comprising or consisting of a polyethylene, wherein the polyethylene has a vinyl index of ≥0.5 and ≤5.0, preferably ≥1.0 and ≤3.0, more preferably ≥1.4 and ≤2.5, wherein the vinyl index (VI) is determined according to the formula:

$$VI = \frac{{A}_{908} - {A}_{933}}{{A}_{1897} - {A}_{1986}}$$

wherein A₉₀₈ is the absorbance at 908 cm⁻¹, A₉₃₃ is the absorbance at 933 cm 1, A₁₈₉₇ is the absorbance at 1897 cm⁻¹, and A₁₉₈₆ is the absorbance at 1986 cm⁻¹ of a Fourier Transform Infrared (FTIR) spectrum of a sample of the material composition measured in transmission mode, and wherein the material composition comprises ≥600 and ≤1500 ppm by weight of secondary antioxidant, with regard to the total weight of the polyethylene in the material composition. Such material composition may for example comprise ≥70.0 wt % of polyethylene, preferably ≥80.0 wt % with regard to the total weight of the composition.

In a further embodiment, the invention also relates to the use of a method comprising
i) providing a material composition comprising or consisting of polyethylene;
ii) determining the quantity of vinyl unsaturations in the polyethylene;
iii) determining the quantity of secondary antioxidant in the material composition; and
iv) adjusting the quantity of secondary antioxidant to correspond to the quantity of secondary antioxidant as required for a polyethylene having a quantity of vinyl unsaturations as determined under ii) for the reduction of the formation of long-chain branches in the polyethylene in the material composition.

The invention will now be illustrated by the following non-limiting examples.

### Materials Used:

| | |
|---|---|
| HDPE | B6246LS, a high-density polyethylene having |
| | a density of 961 kg/m³, obtainable |
| | from SABIC |
| PP | PP525P, a polypropylene homopolymer, |
| | obtainable from SABIC |
| AO2 | Irgafos 168, a secondary antioxidant (tris |
| | (2,4-di-t-butyl phenyl) phosphite), |
| | obtainable from BASF |

### Formulations

| Example | HDPE (part by weight) | PP (part by weight) | AO2 (ppm) |
|---|---|---|---|
| A | 100.0 | — | 1012 |
| B | 100.0 | — | 473 |
| C | 90.0 | 10.0 | 132 |

The above formulations were subjected to extrusion compounding at a melt temperature of 230° C. Of each of the compositions, the below properties were determined after 1 single extrusion pass, after 3 extrusion passes, and after 5 extrusion passes, thereby demonstrating the stability of materials in a recycling process.

| Example | Pass | Vinyl index | LCBf | AO2 | MFR5 |
|---|---|---|---|---|---|
| A | 1 | 1.92 | 0.0012 | 1012 | 3.49 |
| | 3 | 1.94 | 0.0019 | 982 | 3.18 |
| | 5 | 1.92 | 0.0025 | 817 | 3.24 |
| B | 1 | 1.91 | 0.0019 | 474 | 3.80 |
| | 3 | 1.85 | 0.0013 | 275 | 3.28 |
| | 5 | 1.82 | 0.0021 | 63 | 3.30 |
| C | 1 | 1.91 | 0.018 | 132 | 3.80 |
| | 3 | 1.88 | 0.018 | 83 | 3.60 |
| | 5 | 1.87 | 0.016 | 28 | 3.57 |

Wherein:
The vinyl index is determined via FTIR in accordance with the method of the description.
LCBf is the long-chain branching frequency in branches per 1000 carbon atoms, as determined via gel permeation chromatography (GPC).
AO2 is the total secondary antioxidant content of the material, in ppm by weight with regard to the total weight of the sample, determined via the method of ASTM D6953-11.
MFR5 is the melt volume flow rate in cm³/10 min, determined at 5.0 kg load at 190° C. in accordance with ISO 1133

1. A method for stabilising a material composition comprising polyethylene, the method comprising:
i) providing a material composition comprising a polyethylene;
ii) determining the quantity of vinyl unsaturations in the polyethylene;
iii) determining the quantity of secondary antioxidant in the material composition;
iv) adding a quantity of secondary antioxidant so that the quantity of secondary antioxidant in the polyethylene is as required for a polyethylene having a quantity of vinyl unsaturations as determined under ii) to obtain a modified material composition.

2. The method according to claim 1, wherein the secondary antioxidant that is added in step iv) is a monophosphite.

3. The method according to claim 1, wherein the polyethylene comprises a quantity of vinyl unsaturations determined as the vinyl index of ≥0.5 and ≤5.0, wherein the vinyl index (VI) is determined according to the formula:
$$VI = \frac{{A}_{908} - {A}_{933}}{{A}_{1897} - {A}_{1986}}$$
wherein A₉₀₈ is the absorbance at 908 cm⁻¹, A₉₃₃ is the absorbance at 933 cm⁻¹, A₁₈₉₇ is the absorbance at 1897 cm⁻¹, and A₁₉₈₆ is the absorbance at 1986 cm⁻¹ of a Fourier Transform Infrared spectrum of a sample of the material composition, measured in transition mode.

4. The method according to claim 3, wherein the addition under step iv) is such that the ratio of total secondary antioxidant to the vinyl index in the polyethylene in the modified material composition is ≥300 and ≤500 ppm by weight, wherein the total secondary antioxidant content is determined by HPLC.

5. The method according to claim 3, wherein the modified material composition comprises ≥600 and ≤1500 ppm by weight of secondary antioxidant, with regard to the total weight of the polyethylene in the modified material composition.

6. The method according to claim 1, wherein the material composition is a waste plastic composition.

7. The method according to claim 6, wherein the waste plastic composition is a composition comprising ≥70.0 wt % of polyethylene, with regard to the total weight of the waste plastic composition.

8. The method according to claim 6, wherein the waste plastic composition comprises ≤20.0 wt %, of polypropylene, with regard to the total weight of the waste plastic composition.

9. The method according to claim 1, wherein the polyethylene is a low-density polyethylene, a linear low-density polyethylene, a high-density polyethylene, or a mixture thereof.

10. The method according to claim 1, wherein the polyethylene has a molecular weight distribution M_{w}/Mₙ of ≥2.0 and ≤50.0, wherein M_{w} is the weight-average molecular weight, and Mₙ is the number-average molecular weight, each determined in accordance with ASTM D6774-20.

11. The method according to claim 1, wherein the modified material composition comprises ≥500 and ≤2500 ppm by weight of a primary antioxidant, and/or ≥500 and ≤2500 ppm by weight of calcium stearate or zinc stearate.

12. The method according to claim 1, wherein the method further comprises, subsequent to the steps i)-iv), a step v) of processing the modified material composition via a thermal shaping process at a temperature of ≤250° C. to obtain a shaped object.

13. A material composition comprising of a polyethylene, wherein the polyethylene has a vinyl index of ≥0.5 and ≤5.0, wherein the vinyl index (VI) is determined according to the formula:
$$VI = \frac{{A}_{908} - {A}_{933}}{{A}_{1897} - {A}_{1986}}$$
wherein A₉₀₈ is the absorbance at 908 cm⁻¹, A₉₃₃ is the absorbance at 933 cm⁻¹, A₁₈₉₇ is the absorbance at 1897 cm⁻¹, and A₁₉₈₆ is the absorbance at 1986 cm⁻¹ of a Fourier Transform Infrared spectrum of a sample of the material composition measured in transmission mode, and wherein the material composition comprises ≥600 and ≤1500 ppm by weight of a secondary antioxidant, with regard to the total weight of the polyethylene in the material composition.

14. The material composition according to claim 13, wherein the composition comprises ≥70.0 wt % of polyethylene, with regard to the total weight of the composition.

15. (canceled)

16. The method according to claim 2, wherein the secondary antioxidant that is added in step iv) is tris(2,4-di-t-butyl phenyl)phosphite.
